(19) United States
(12) Patent Application Publication
(10) Pub. No.: US 2007/0133711 A1
(43) Pub. Date: Jun. 14, 2007

(54) Transmission interface module for digital and continuous-waveform transmission signals

(76) Inventor: Weidong Li, Los Gatos, CA (US)

Correspondence Address: GARLICK HARRISON & MARKISON, P.O. BOX 160727, AUSTIN, TX, 78716-0727, US

(21) Appl. No.: 11/298,432

(22) Filed: Dec. 9, 2005

(51) Int. Cl. H04L 27/00

(52) U.S. Cl. 375/295

(57) ABSTRACT

An integrated circuit radio transmitter includes a baseband processing module that is operable to generate digital data for transmission through a wireless interface, first transmission logic for generating first continuous waveform transmission signals, second transmission logic for generating second continuous waveform transmission signals, and third transmission logic for generating digital transmission signals. The integrated circuit radio transmitter also includes logic for selecting an output transmission signal format including at least one of the first continuous waveform transmission signals, the second continuous waveform transmission signals, and the digital transmission signals; and radio frequency (“RF”) transmission circuitry for receiving and transmitting the selected output transmission signal format.

### BACKGROUND

1. Technical Field

The present invention relates to wireless communications and, more particularly, to radio signal transmitter interfaces.

2. Related Art

Communication systems are known to support wireless and wire-line communications between wireless and/or wire-line communication devices. Such communication systems range from national and/or international cellular telephone systems to the Internet to point-to-point in-home wireless networks. Each type of communication system is constructed, and hence operates, in accordance with one or more communication standards. For instance, wireless communication systems may operate in accordance with one or more standards, including, but not limited to, IEEE 802.1 1, Bluetooth, advanced mobile phone services (“AMPS”), digital AMPS, global system for mobile communications (“GSM”), code division multiple access (“CDMA”), local multi-point distribution systems (“LMDS”), multi-channel-multi-point distribution systems (“MMDS”), and/or variations thereof.

Depending on the type of wireless communication system, a wireless communication device, such as a cellular telephone, two-way radio, personal digital assistant (“PDA”), personal computer (“PC”), laptop computer, home entertainment equipment, etc., communicates directly or indirectly with other wireless communication devices. For direct communications (also known as point-to-point communications), the participating wireless communication devices tune their receivers and transmitters to the same channel or channels (for example, one of a plurality of radio frequency (“RF”) carriers of the wireless communication system) and communicate over that channel(s). For indirect wireless communications, each wireless communication device communicates directly with an associated base station (for example, for cellular services) and/or an associated access point (for example, for an in-home or in-building wireless network) via an assigned channel. To complete a communication connection between the wireless communication devices, the associated base stations and/or associated access points communicate with each other directly, via a system controller, via a public switch telephone network (“PSTN”), via the Internet, and/or via some other wide area network.

Each wireless communication device includes a built-in radio transceiver (that is, receiver and transmitter) or is coupled to an associated radio transceiver (for example, a station for in-home and/or in-building wireless communication networks, RF modem, etc.). As is known, the transmitter includes a data modulation stage, one or more intermediate frequency stages, and a power amplifier stage. The data modulation stage converts raw data into baseband signals in accordance with the particular wireless communication standard. The one or more intermediate frequency stages mix the baseband signals with one or more local oscillations to produce RF signals. The power amplifier stage amplifies the RF signals prior to transmission via an antenna.

Typically, the data modulation stage is implemented on a baseband processor chip, while the intermediate frequency (“IF”) stages and power amplifier stage are implemented on a separate radio processor chip. Historically, radio integrated circuits have been designed using bi-polar circuitry, allowing for large signal swings and linear transmitter component behavior. Therefore, many legacy baseband processors employ analog interfaces that communicate analog signals to and from the radio processor.

One common problem in signal transmission is for the baseband processor chip to accommodate a variety of conventional, or analog, radio-frequency transmitter architectures and digital transmitter architectures used in radio processor chips. Such architectures may accommodate intermediate frequency, very low intermediate frequency, or baseband (direct conversion) frequency signals, as well as digital signal formats based on baseband/RF interface specifications, such as the digRF specification. Though baseband processor chip technology advances, the radio processor chip technology may not advance at a similar rate, discouraging the adoption of the improved technologies. What is needed therefore is a baseband processor chip that has the capability to accommodate the variety of RF transmitter architectures, while taking advantage of the increased processing power and capabilities of the baseband processor chip.

### SUMMARY OF THE INVENTION

The present invention is directed to apparatus and methods of operation that are further described in the following Brief Description of the Drawings, the Detailed Description of the Drawings, and the claims. Other features and advantages of the present invention will become apparent from the following detailed description of the invention made with reference to the accompanying drawings.

### BRIEF DESCRIPTION OF THE DRAWINGS

A better understanding of the present invention can be obtained when the following detailed description of the preferred embodiment is considered with the following drawings, in which:

FIG. 1 is a functional block diagram illustrating a communication system that includes circuit devices and network elements and operation thereof according to one embodiment of the invention.

FIG. 2 is a schematic block diagram illustrating a wireless communication host device and an associated radio;

FIG. 3 is a schematic block diagram illustrating a wireless communication device that includes a host device and an associated radio;

FIG. 4 is a functional block diagram of a transmission interface module according to one embodiment of the present invention;

FIG. 5 is a schematic block diagram of the transmission interface module according to one embodiment of the invention;

FIG. 6 is a functional block diagram of transmission logic for a digital transmission signal according to one embodiment of the invention;

FIG. 7 illustrates a state machine for the transmission logic of FIG. 6;

FIG. 8 is a timing block diagram relating to the third transmission logic of FIG. 6; and

FIG. 9 is a flow chart illustrating a method for providing multiple signal formats according to an embodiment of the invention.

### DETAILED DESCRIPTION OF THE DRAWINGS

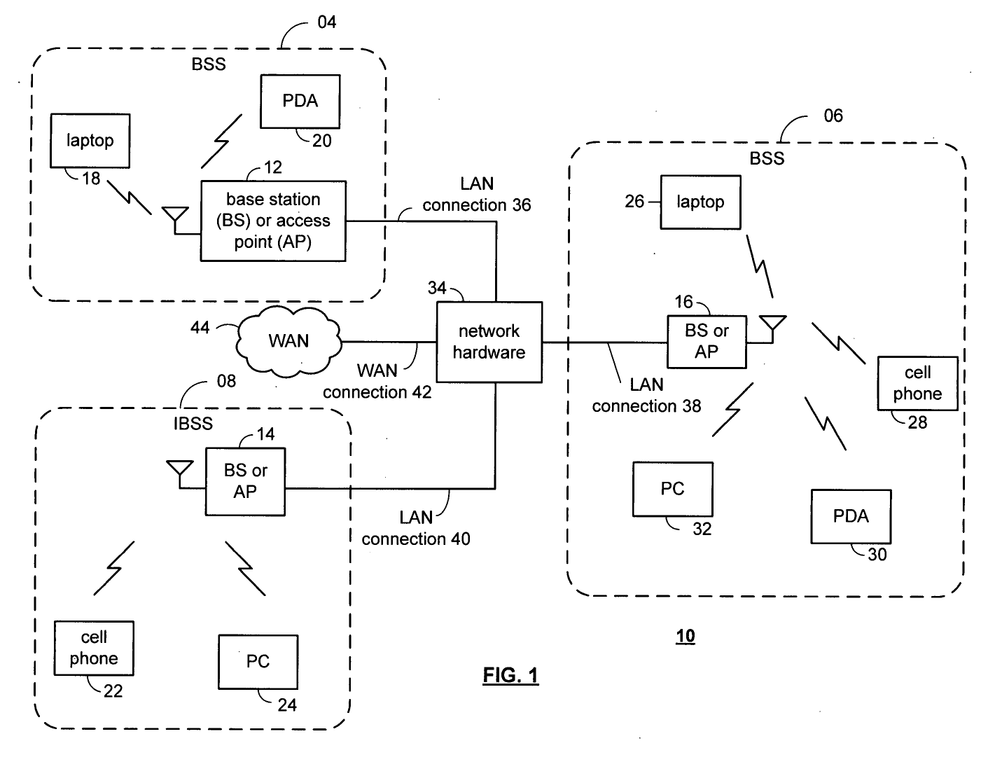

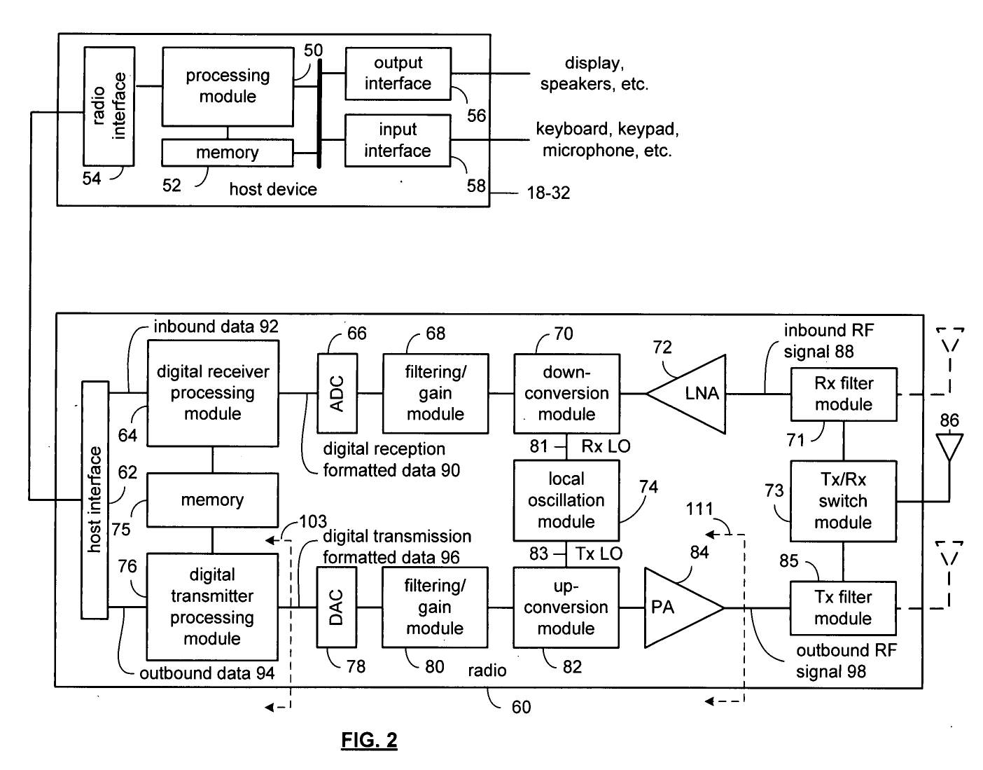

FIG. 1 is a functional block diagram illustrating a communication system that includes circuit devices and network elements and operation thereof according to one embodiment of the invention. More specifically, a plurality of network service areas 04, 06 and 08 are a part of a network 10. Network 10 includes a plurality of base stations or access points (“APs”) 12-16, a plurality of wireless communication devices 18-32 and a network hardware component 34. The wireless communication devices 18-32 may be laptop computers 18 and 26, personal digital assistants 20 and 30, personal computers 24 and 32 and/or cellular telephones 22 and 28. The details of the wireless communication devices will be described in greater detail with reference to FIGS. 2-9.

The base stations or APs 12-16 are operably coupled to the network hardware component 34 via local area network (“LAN”) connections 36, 38 and 40. The network hardware component 34, which may be a router, switch, bridge, modem, system controller, etc., provides a wide area network (“WAN”) connection 42 for the communication system 10 to an external network element such as WAN 44. Each of the base stations or access points 12-16 has an associated antenna or antenna array to communicate with the wireless communication devices in its area. Typically, the wireless communication devices 18-32 register with the particular base station or access points 12-16 to receive services from the communication system 10. For direct connections (that is, point-to-point communications), wireless communication devices communicate directly via an allocated channel.

Typically, base stations are used for cellular telephone systems and like-type systems, while access points are used for in-home or in-building wireless networks. Regardless of the particular type of communication system, each wireless communication device includes a built-in radio and/or is coupled to a radio.

FIG. 2 is a schematic block diagram illustrating a wireless communication host device 18-32 and an associated radio 60. For cellular telephone hosts, radio 60 is a built-in component. For personal digital assistants hosts, laptop hosts, and/or personal computer hosts, the radio 60 may be built-in or an externally coupled component.

As illustrated, wireless communication host device 18-32 includes a processing module 50, a memory 52, a radio interface 54, an input interface 58 and an output interface 56. Processing module 50 and memory 52 execute the corresponding instructions that are typically done by the host device. For example, for a cellular telephone host device, processing module 50 performs the corresponding communication functions in accordance with a particular cellular telephone standard.

Radio interface 54 allows data to be received from and sent to radio 60. For data received from radio 60 (for example, inbound data), radio interface 54 provides the data to processing module 50 for further processing and/or routing to output interface 56. Output interface 56 provides connectivity to an output device such as a display, monitor, speakers, etc., such that the received data may be displayed. Radio interface 54 also provides data from processing module 50 to radio 60. Processing module 50 may receive the outbound data from an input device such as a keyboard, keypad, microphone, etc., via input interface 58 or generate the data itself. For data received via input interface 58, processing module 50 may perform a corresponding host function on the data and/or route it to radio 60 via radio interface 54.

Radio 60 includes a host interface 62, a digital receiver processing module 64, an analog-to-digital converter 66, a filtering/gain module 68, a down-conversion module 70, a low noise amplifier 72, a receiver filter module 71, a transmitter/receiver (“Tx/Rx”) switch module 73, a local oscillation module 74, a memory 75, a digital transmitter processing module 76, a digital-to-analog converter 78, a filtering/gain module 80, an up-conversion module 82, a power amplifier 84, a transmitter filter module 85, and an antenna 86 operatively coupled as shown. The antenna 86 is shared by the transmit and receive paths as regulated by the Tx/Rx switch module 73. The antenna implementation will depend on the particular standard to which the wireless communication device is compliant.

Digital receiver processing module 64 and digital transmitter processing module 76, in combination with operational instructions stored in memory 75, execute digital receiver functions and digital transmitter functions, respectively. The digital receiver functions include, but are not limited to, demodulation, constellation demapping, decoding, and/or descrambling. The digital transmitter functions include, but are not limited to, scrambling, encoding, constellation mapping, and modulation. Digital receiver and transmitter processing modules 64 and 76, respectively, may be implemented using a shared processing device, individual processing devices, or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions.

Memory 75 may be a single memory device or a plurality of memory devices. Such a memory device may be a read-only memory, random access memory, volatile memory, non-volatile memory, static memory, dynamic memory, flash memory, and/or any device that stores digital information. Note that when digital receiver processing module 64 and/or digital transmitter processing module 76 implements one or more of its functions via a state machine, analog circuitry, digital circuitry, and/or logic circuitry, the memory storing the corresponding operational instructions is embedded with the circuitry comprising the state machine, analog circuitry, digital circuitry, and/or logic circuitry. Memory 75 stores, and digital receiver processing module 64 and/or digital transmitter processing module 76 executes, operational instructions corresponding to at least some of the functions illustrated herein.

In operation, radio 60 receives outbound data 94 from wireless communication host device 18-32 via host interface 62. Host interface 62 routes outbound data 94 to digital transmitter processing module 76, which processes outbound data 94 in accordance with a particular wireless communication standard or protocol (for example, IEEE 802.11a, IEEE 802.11b, IEEE 802.11g, IEEE 802.11n, Bluetooth, etc.) to produce digital transmission formatted data 96. Digital transmission formatted data 96 will be a digital baseband signal or a digital low IF signal, where the low IF typically will be in the frequency range of one hundred kilohertz to a few megahertz.

Digital-to-analog converter 78 converts digital transmission formatted data 96 from the digital domain to the analog domain. Filtering/gain module 80 filters and/or adjusts the gain of the analog baseband signal prior to providing it to up-conversion module 82. Up-conversion module 82 directly converts the analog baseband signal, or low IF signal, into an RF signal based on a transmitter local oscillation 83 provided by local oscillation module 74. Power amplifier 84 amplifies the RF signal to produce an outbound RF signal 98, which is filtered by transmitter filter module 85. The antenna 86 transmits outbound RF signal 98 to a targeted device such as a base station, an access point and/or another wireless communication device.

Radio 60 also receives an inbound RF signal 88 via antenna 86, which was transmitted by a base station, an access point, or another wireless communication device. The antenna 86 provides inbound RF signal 88 to receiver filter module 71 via Tx/Rx switch module 73, where Rx filter module 71 bandpass filters inbound RF signal 88. The Rx filter module 71 provides the filtered RF signal to low noise amplifier 72, which amplifies inbound RF signal 88 to produce an amplified inbound RF signal. Low noise amplifier 72 provides the amplified inbound RF signal to down-conversion module 70, which directly converts the amplified inbound RF signal into an inbound low IF signal or baseband signal based on a receiver local oscillation 81 provided by local oscillation module 74. Down-conversion module 70 provides the inbound low IF signal or baseband signal to filtering/gain module 68. Filtering/gain module 68 may be implemented in accordance with the teachings of the present invention to filter and/or attenuate the inbound low IF signal or the inbound baseband signal to produce a filtered inbound signal.

Analog-to-digital converter 66 converts the filtered inbound signal from the analog domain to the digital domain to produce digital reception formatted data 90. Digital receiver processing module 64 decodes, descrambles, demaps, and/or demodulates digital reception formatted data 90 to recapture inbound data 92 in accordance with the particular wireless communication standard being implemented by radio 60. Host interface 62 provides the recaptured inbound data 92 to the wireless communication host device 18-32 via radio interface 54.

As one of average skill in the art will appreciate, the wireless communication device of FIG. 2 may be implemented using one or more integrated circuits. For example, the host device may be implemented on a first integrated circuit, while digital receiver processing module 64, digital transmitter processing module 76 and memory 75 may be implemented on a second integrated circuit, and the remaining components of radio 60, less antenna 86, may be implemented on a third integrated circuit. As an alternate example, radio 60 may be implemented on a single integrated circuit. As yet another example, processing module 50 of the host device and digital receiver processing module 64 and digital transmitter processing module 76 may be a common processing device implemented on a single integrated circuit.

Memory 52 and memory 75 may be implemented on a single integrated circuit and/or on the same integrated circuit as the common processing modules of processing module 50, digital receiver processing module 64, and digital transmitter processing module 76. As will be described, it is important that accurate oscillation signals are provided to mixers and conversion modules. A source of oscillation error is noise coupled into oscillation circuitry through integrated circuitry biasing circuitry. One embodiment of the present invention reduces the noise by providing a selectable pole low pass filter in current mirror devices formed within the one or more integrated circuits.

The digital transmitter processing module 76 may be incorporated on an integrated circuit with selection logic to select output transmission signal formats, such as digital and/or analog formats. The transmission signal formats may be based on baseband domain functionality to produce digital transmission formatted data 96, as indicated by the dashed line 103, or baseband domain and an intermediate frequency (including VLIF) stage(s) or a direct conversion functionality, as indicated by the dashed line 111, to produce outbound RF signal 98. Depending on the selected function of the digital transmitter processing module 76, complementary components are provided by a radio processor chip, which may be provided as a separate integrated circuit, or as a multi-chip module, chip-on-board, and/or deeper integration IC, etc., that combine analog circuitry with digital circuitry, for remaining functional portions of the transmitter channel for transmission via the antenna 86.

Local oscillation module 74 includes circuitry for adjusting an output frequency of a local oscillation signal provided therefrom. Local oscillation module 74 receives a frequency correction input that it uses to adjust an output local oscillation signal to produce a frequency corrected local oscillation signal output. While local oscillation module 74, up-conversion module 82 and down-conversion module 70 are implemented to perform direct conversion between baseband and RF, it is understood that the principles herein may also be applied readily to systems that implement an intermediate frequency conversion step at a low intermediate frequency (such as with a superhetrodyne architecture).

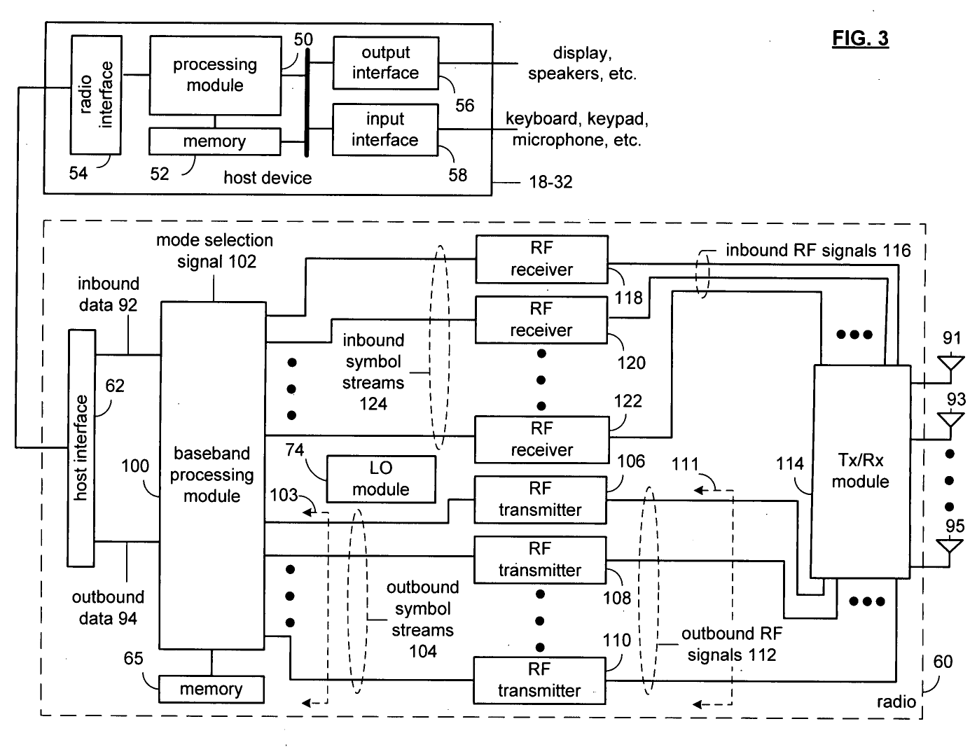

FIG. 3 is a schematic block diagram illustrating a wireless communication device that includes the host device 18-32 and an associated radio 60. For cellular telephone hosts, the radio 60 is a built-in component. For personal digital assistants hosts, laptop hosts, and/or personal computer hosts, the radio 60 may be built-in or an externally coupled component.

As illustrated, the host device 18-32 includes a processing module 50, memory 52, radio interface 54, input interface 58 and output interface 56. The processing module 50 and memory 52 execute the corresponding instructions that are typically done by the host device. For example, for a cellular telephone host device, the processing module 50 performs the corresponding communication functions in accordance with a particular cellular telephone standard.

The radio interface 54 allows data to be received from and sent to the radio 60. For data received from the radio 60 (for example, inbound data), the radio interface 54 provides the data to the processing module 50 for further processing and/or routing to the output interface 56. The output interface 56 provides connectivity to an output display device such as a display, monitor, speakers, etc., such that the received data may be displayed. The radio interface 54 also provides data from the processing module 50 to the radio 60. The processing module 50 may receive the outbound data from an input device such as a keyboard, keypad, microphone, etc., via the input interface 58 or generate the data itself. For data received via the input interface 58, the processing module 50 may perform a corresponding host function on the data and/or route it to the radio 60 via the radio interface 54.

Radio 60 includes a host interface 62, a baseband processing module 100, memory 65, a plurality of radio frequency (“RF”) transmitters 106-110, a transmit/receive (“T/R”) module 114, a plurality of antennas 91-95, a plurality of RF receivers 118-120, and a local oscillation module 74. The baseband processing module 100, in combination with operational instructions stored in memory 65, executes digital receiver functions and digital transmitter functions, respectively. The digital receiver functions include, but are not limited to, digital intermediate frequency to baseband conversion, demodulation, constellation demapping, decoding, de-interleaving, fast Fourier transform, cyclic prefix removal, space and time decoding, and/or descrambling. The digital transmitter functions include, but are not limited to, scrambling, encoding, interleaving, constellation mapping, modulation, inverse fast Fourier transform, cyclic prefix addition, space and time encoding, and digital baseband to IF conversion. The baseband processing module 100 may be implemented using one or more processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The memory 65 may be a single memory device or a plurality of memory devices. Such a memory device may be a read-only memory, random access memory, volatile memory, non-volatile memory, static memory, dynamic memory, flash memory, and/or any device that stores digital information. Note that when the baseband processing module 100 implements one or more of its functions via a state machine, analog circuitry, digital circuitry, and/or logic circuitry, the memory storing the corresponding operational instructions is embedded with the circuitry comprising the state machine, analog circuitry, digital circuitry, and/or logic circuitry.

In operation, the radio 60 receives outbound data 94 from the host device via the host interface 62. The baseband processing module 100 receives the outbound data 94 and, based on a mode selection signal 102, produces one or more outbound symbol streams 104. The mode selection signal 102 will indicate a particular mode of operation that is compliant with one or more specific modes of the various IEEE 802.11, TIA, and/or 3GPP wireless standards specifications. For example, the mode selection signal 102 may indicate a frequency band of 2.4 GHz, a channel bandwidth of 20 or 22 MHz and a maximum bit rate of 54 megabits-per-second. In this general category, the mode selection signal will further indicate a particular rate ranging from 1 megabit-per-second to 54 megabits-per-second. In addition, the mode selection signal will indicate a particular type of modulation, which includes, but is not limited to, Barker Code Modulation, BPSK, QPSK, CCK, 8PSK, 16 QAM and/or 64 QAM. The mode selection signal 102 may also include a code rate, a number of coded bits per subcarrier (“NBPSC”), coded bits per OFDM symbol (“NCBPS”), and/or data bits per OFDM symbol (“NDBPS”). The mode selection signal 102 may also indicate a particular channelization for the corresponding mode that provides a channel number and corresponding center frequency. The mode selection signal 102 may further indicate a power spectral density mask value and a number of antennas to be initially used for a MIMO communication.

The baseband processing module 100, based on the mode selection signal 102 produces one or more outbound symbol streams 104 from the outbound data 94 for transmission through a wireless interface. For example, if the mode selection signal 102 indicates that a single transmit antenna is being utilized for the particular mode that has been selected, the baseband processing module 100 will produce a single outbound symbol stream 104. Alternatively, if the mode selection signal 102 indicates 2, 3 or 4 antennas, the baseband processing module 100 will produce 2, 3 or 4 outbound symbol streams 104 from the outbound data 94.

Depending on the number of outbound symbol streams 104 produced by the baseband processing module 100, a corresponding number of the RF transmitters 106-110 will be enabled to convert the outbound symbol streams 104 into outbound RF signals 112. In general, each of the RF transmitters 106-110 includes a digital filter and upsampling module, a digital-to-analog conversion module, an analog filter module, a frequency up conversion module, a power amplifier, and a radio frequency bandpass filter. The RF transmitters 106-110 provide the outbound RF signals 112 to the transmit/receive module 114, which provides each outbound RF signal to a corresponding antenna 81-85.

When the radio 60 is in the receive mode, the transmit/receive module 114 receives one or more inbound RF signals 116 via the antennas 81-85 and provides them to one or more RF receivers 118-122. The RF receiver 118-122 converts the inbound RF signals 116 into a corresponding number of inbound symbol streams 124. The number of inbound symbol streams 124 will correspond to the particular mode in which the data was received. The baseband processing module 100 converts the inbound symbol streams 124 into inbound data 92, which is provided to the host device 18-32 via the host interface 62.

As one of average skill in the art will appreciate, the wireless communication device of FIG. 3 may be implemented using one or more integrated circuits. For example, the host device may be implemented on a first integrated circuit, the baseband processing module 100 and memory 65 may be implemented on a second integrated circuit, and the remaining components of the radio 60, less the antennas 81-85, may be implemented on a third integrated circuit. As an alternate example, the radio 60 may be implemented on a single integrated circuit. As yet another example, the processing module 50 of the host device and the baseband processing module 100 may be a common processing device implemented on a single integrated circuit. Further, the memory 52 and memory 65 may be implemented on a single integrated circuit and/or on the same integrated circuit as the common processing modules of processing module 50 and the baseband processing module 100.

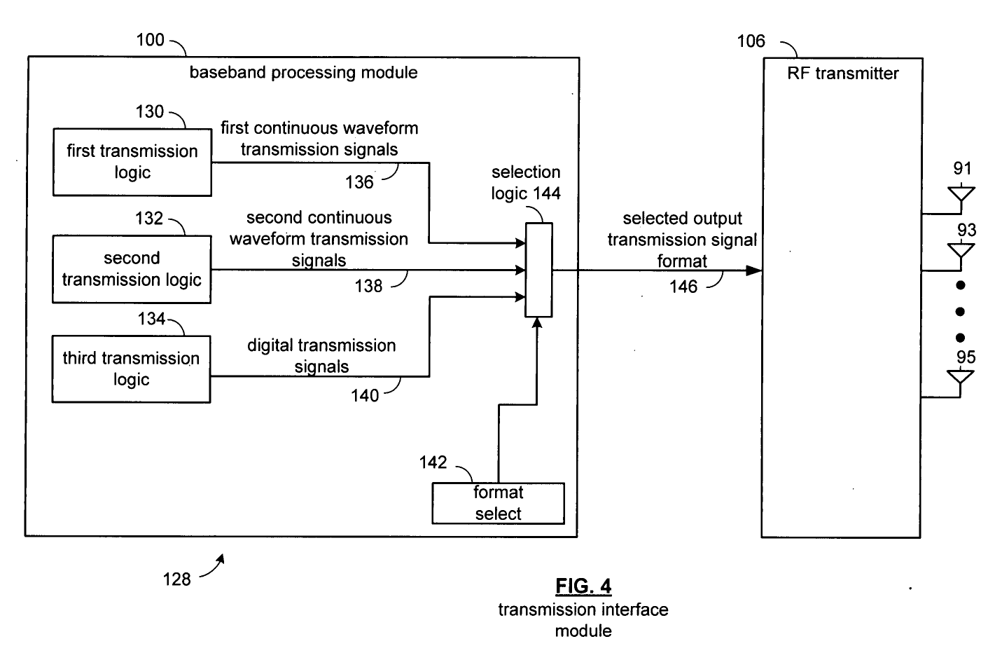

The baseband processing module 100 may be incorporated on an integrated circuit that with selection logic to select output transmission signal formats, such as digital and/or analog formats. The transmission signal formats may be based on baseband domain functionality to produce outbound symbol streams 104, as indicated by the dashed line 103, or baseband domain and an intermediate frequency (including VLIF stage(s)) or a direction conversion functionality, as indicated by the dashed line 111, to produce outbound RF signals 112. Depending on the selected function of the baseband processing module 100, complementary components are provided by a RF transmitter chip, or chips, such as the RF transmitters 106-110, which with respect to the baseband processing module 100, may be provided as separate integrated circuits, or as a multi-chip module, chip-on-board (“COB”), and/or deeper integration IC, etc., that combine analog circuitry with digital circuitry for remaining functional portions to complete the transmitter channel for transmission via the antenna 91-95. The selectable functionality of the baseband processing module 100, and the digital transmitter processing module 76, is discussed in detail with reference to FIGS. 4 through 9.

FIG. 4 is a functional block diagram of a transmission interface module 128 that includes a first transmission logic 130, a second transmission logic 132, a third transmission logic 134, a selection logic 144, and a format select 142. The transmission interface module 128 may be implemented with respect to the digital transmission processing module 76 and/or the baseband processing module 100

The first transmission logic 130 provides a first continuous waveform transmission signals 136, the second transmission logic 132 provides second continuous waveform transmission signals 138, and the third transmission logic 134 provides digital transmission signals 140. The transmission signals 136, 138, and 140 are different transmission formats that accommodate complementary RF transmitter architectures, including analog and digital transmission formats. The first continuous waveform transmission signals 136, the second continuous waveform transmission signals 138, and the digital transmission signals 140 are provided to the selection logic 144 which selects a transmission signal of the transmission signals 136, 138, and 140, based upon the format select 142. The format select 142 indicates to the baseband processing module 100 the topology and/or configuration of the RF transmitter 106-110, that is, the radio processor, of the radio 60.

As examples of the analog and digital signal formats, the first continuous waveform transmission signals 136 may be baseband frequency waveform transmission signals, where direct conversion radio techniques up-convert the analog signals for radio transmission. The second continuous waveform transmission signals 138 may be provided as very low intermediate frequency (“VLIF”) waveform transmission signals that a RF transmitter up-converts to the radio frequency over several IF stages for radio transmission. The digital transmission signals 140 may be provided as data signals based on baseband/RF digital interface specifications (for example, the digRF specification).

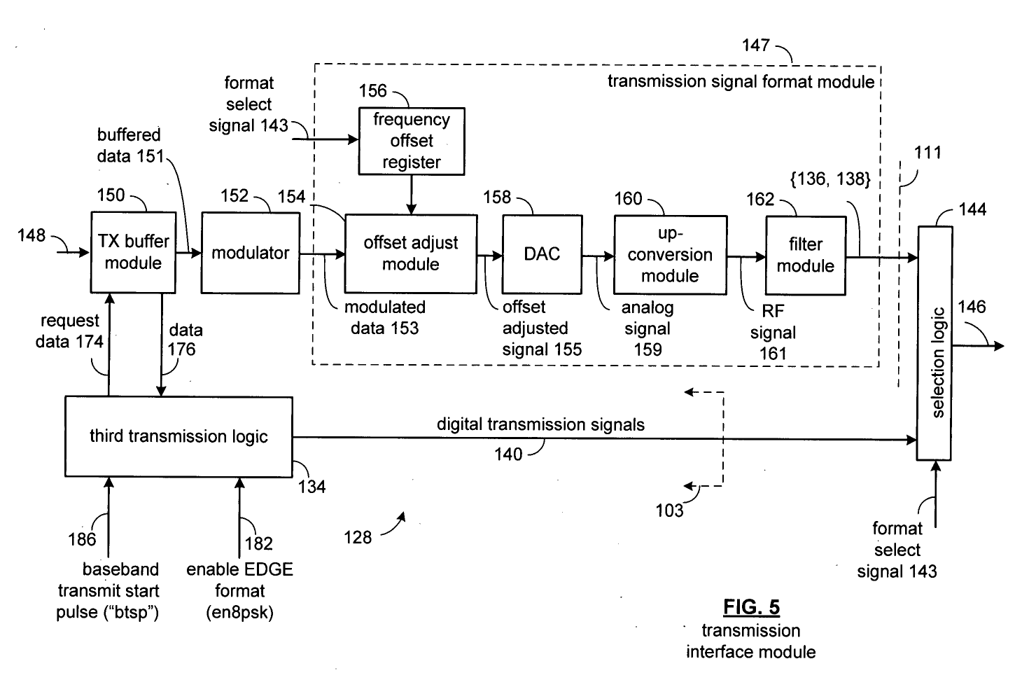

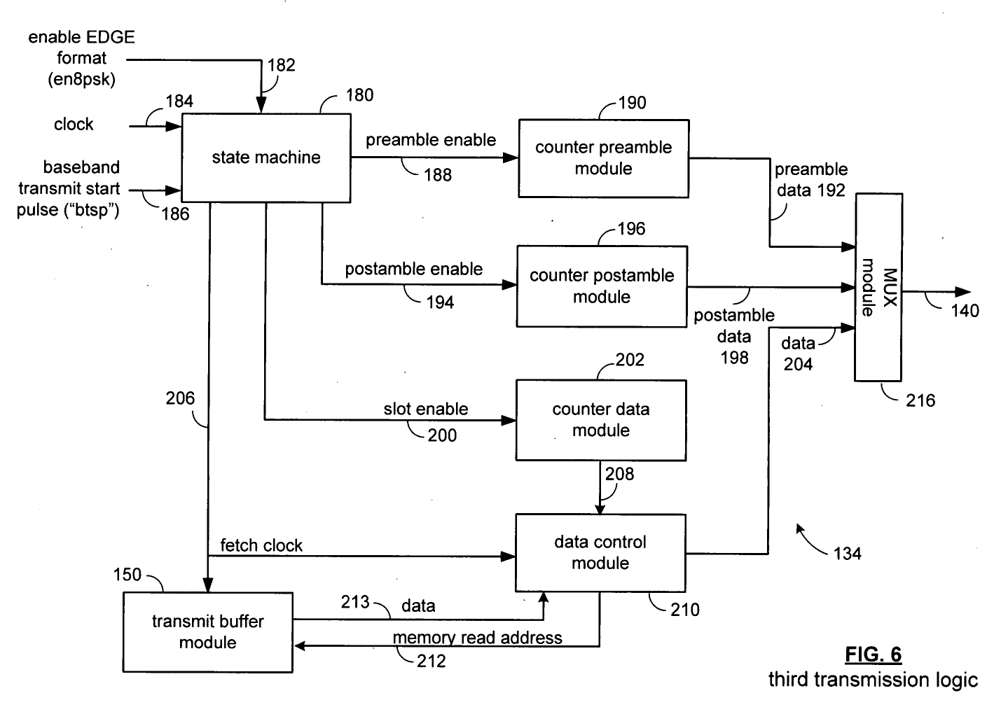

FIG. 5 is a schematic block diagram of the transmission interface module 128 that includes a transmit (“TX”) buffer module 150, a modulator 152, a transmission signal format module 147, and third transmission logic 134, which is discussed in detail with reference to FIG. 6. The transmission signal format module 147 includes an offset adjust module 154 with frequency offset register 156, a digital-to-analog converter (“DAC”) 158, an up-conversion module 160, and a filter module 162.

In operation, the TX buffer module 150 receives and buffers data 148. The third transmission logic 134 may access the TX buffer module 150 via request data signal 174 and data signal 176 to produce digital transmission signals 140. The third transmission logic 134 provides digital transmission signals 140 as an EDGE (Enhanced Data rates in GSM Environment) format, which uses an eight-state phase shift keying (8PSK), that is selected via a logic “high” to the enable EDGE format 182, or as a GPRS (General Packet Radio Services) format, which uses Gaussian minimum shift keying (“GSMK”) format, that is selected via a logic “low” to the enable EDGE format 182.

When the format select signal 143 designates either of the first continuous waveform transmission signals 136 or second continuous waveform transmission signals 138, via the embodiment of the first and second transmission logic 130 and 132 provided by the transmission signal format module 147, the modulator 152 modulates the buffered data 151 to produce modulated data 153 to the offset adjust module 154. Based upon the format select signal 143, the frequency offset register 156 provides an offset value to the offset adjust module 154 such that the modulated data is offset for baseband and/or VLIF transmission. Accordingly, the offset adjust module receives the offset value and the modulated data to provide an offset adjusted signal 155.

Generally, baseband and/or IF transmission architectures are used in ultra compact, low-power, and low-cost wireless application solutions. The direct conversion techniques for baseband transmission provide greater circuit compactness. realization. Each of these architectures, however, has different design considerations.

For baseband transmitter architectures, the desired signal is directly up-converted to a transmission radio frequency, eliminating the multiple IF stages associated with superhetrodyne architectures (such as with IF and/or VLIF architectures) to reduce circuit complexity and cost. A design consideration, for example, of baseband architectures is the presence of DC offsets and second- and third-order intermodulations that may cause difficulty in filtering the noise from the desired signal.

For IF and/or VLIF transmitter architectures, the DC offset is less of a consideration because the frequency is generally situated off of the DC frequency, and further has a very small bandwidth (for example, less than 1 kHz). A design consideration of VLIF architectures, for example, is the heightened accuracy match requirement between components, the phase error introduced by a quadrature oscillator to the up-converters, etc. Given the attributes of either a direct conversion or an intermediate frequency technique, both may be available for RF transmitter devices.

The DAC 158 converts the offset adjusted signal 155 from the digital domain to the analog domain. Up-conversion module 160 up-converts the analog signal 159 (which may be a baseband or a VLIF signal) to an RF signal based on a transmitter local oscillation provided by a LO module 74 (see FIG. 3). After passing through the filter module 162, the transmission signal format module 148 provides either first continuous waveform signals 136 and/or second continuous waveform signals 138, as selected by the format select signal 143. The selection logic 144, based upon the format select signal 143, selects output transmission signal format 146 as between the analog signals of the first and second continuous waveform signals 136 and 138, providing baseband functionality and intermediate and/or radio frequency functionality through to the dashed line 111, and the digital transmission signals 140 to provide baseband functionality through to the dashed line 103.

As one of ordinary skill in the art may appreciate, portions of the transmitter front-end processing occur via the baseband processing module 100. Further, the modulated data 153 may be provided as a quadrature signal including an in-phase (I) component and a quadrature (Q) component. Accordingly, the DAC 158 the in-phase and quadrature components of the filtered low IF signal 127 into corresponding in-phase and quadrature digital signals 150.

FIG. 6 is a functional block diagram of a third transmission logic 134 that includes a state machine 180, a counter preamble module 190, a counter postamble module 196, a counter data module 202, a data control module 210, a transmit buffer module. 150, and a MUX module 216.

In operation, the third transmission logic 134 may generate the digital transmission signals in either an EDGE format, or in a GPRS format. The EDGE format uses 8PSK modulation that allows the coding of three bits per symbol. The GPRS format uses GMSK modulation. For comparison, 8PSK modulation is able to deliver data at about three times the rate of GPRS formats.

The enable EDGE format 182 designates either an EDGE format mode or a GPRS format mode for the data transmission signals 140. As may be appreciated by one of ordinary skill in the art, the baseband processing module 100 issues the enable EDGE format 182 (via a mode selection signal such as signal 102) based upon setup communications with the complementary transmitter components of the radio transmission channel. In this manner, the digital transmission signals are in at least one of a GPRS protocol and an EDGE protocol.

The broadband transmit start pulse (btsp) 156 initiates the transfer of data to the RF transmitter circuitry 106-110. Based on the state machine inputs, the state machine 180, prompts the baseband processing module 100 (or the digital transmitter processing module 76, respectively) to produce the associated preamble and postamble data 192 and 198 and the data 204 to the MUX module 216. The data control module 210 provides the data 204 from the data 213 via the memory read address 212 to access the transmit buffer module 150 according to the fetch clock 206. This data retrieval cycle continues for the duration of the data counter 208 provided by the counter data module 202, which is enabled by the state machine 180 via the slot enable 200.

The preamble data 192 and the postamble data 198 are sequences of known symbols designated by the appropriate communications specification, such as GPRS or EDGE. Generally, the preamble and the postamble carry overhead information for control purposes, such as carrier recovery, burst synchronization, signaling, training, error-monitoring and others.

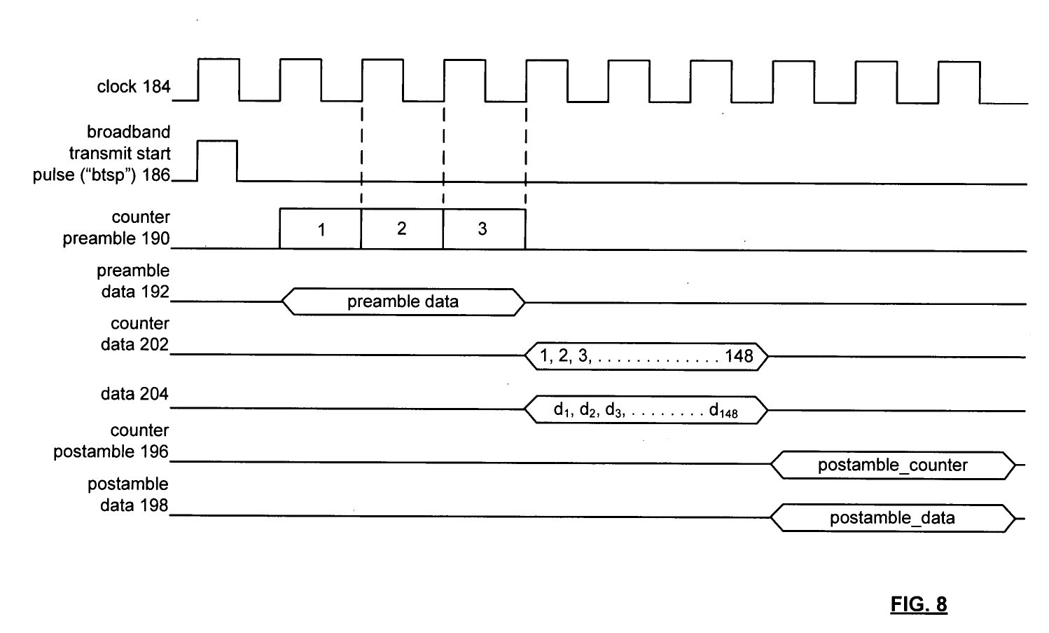

In operation, the MUX module 216 assembles digital transmission signals 140 from the preamble data 192, the data 204, and the postamble data 198 according to the sequences dictated by the state machine 180 based on the applicable communications specification (for example, GPRS and/or EDGE). The timing sequences of the data, preamble data, and postamble data is discussed with reference to FIG. 8.

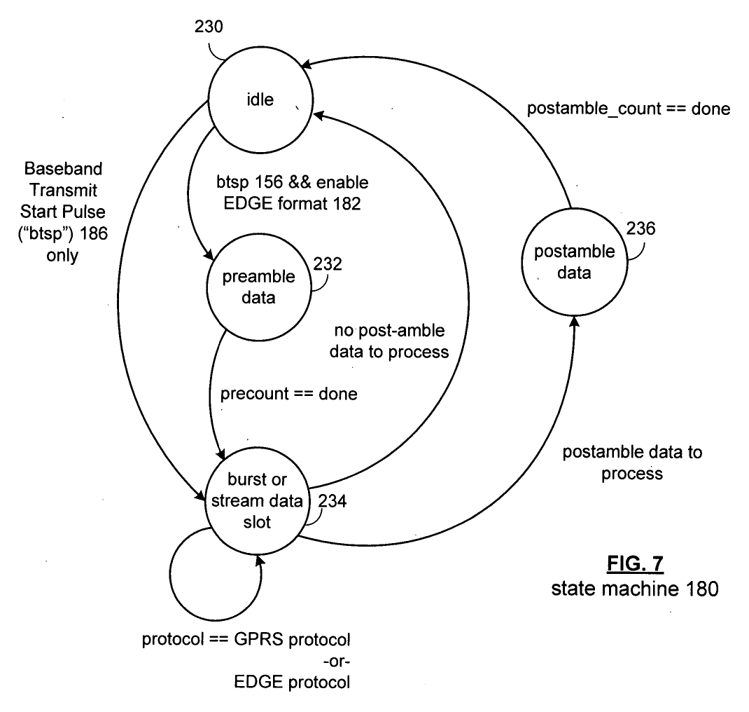

FIG. 7 illustrates a state machine 180 for the third transmission logic 134 of FIG. 6. At the idle state 230, inputs are received with respect to the enable EDGE format 182, for transmission under the EDGE protocol, and to initiate btsp 186. With a btsp 156 and an enable EDGE format 152, the state machine 180 progresses to a preamble data state 232. At the preamble data state 232, preamble data is generated according to the EDGE specification and the counter preamble module 190. Upon completion of the precount for the preamble data 192, the burst or stream data slot state 234 is entered, in which the data 213 is assembled by the MUX module 216 and provided in a burst or stream data slot. In a burst slot, radios can encode, transmit, and decode the digital information in a fraction of the time used to produce the sound and/or information. The advantage is that the signal is in the communication channel for a fraction of the overall transmission time. In contrast, a data stream slot does not rely upon burst transmission techniques. When the data formatting is complete, as indicated by the counter data module 202, the postamble data is presented for processing in which a postamble state 236 is entered. At state 236, the postamble data is processed, or appended, to the digital transmission signals 140 with respect to the counter postamble module 202. Upon completion of the postamble count, the state machine returns to the idle state 190.

When btsp 186 is initiated without an accompanying logic “true” enable EDGE format 182, the state machine 180 prompts the baseband processing module 100 to produce GPRS-formatted digital transmission signals 140, and enters the burst or stream data state 234. At this juncture, the GMSK modulation generates the signal under the GPRS protocol. When the data processing at state 194 completes, a determination is made as to whether a postamble is applied to the digital transmission signals 140. When no postamble data is to be applied, the process returns to the idle state 190.

FIG. 8 is a timing block diagram relating to the third transmission logic 134 of FIG. 6. The timing diagram illustrates an EDGE format wherein the three data varieties are present, including the preamble data 192, data 204 and postamble data 198. With respect to the clock 154, upon initiation of a broadband transmit start pulse (“btsp”) 186, the counter preamble module 190 provides a timer sequence during which time the preamble data 192 is provided to the MUX module 216. Following the preamble data 192, the counter data module 202 provides a counter sequence (for example, a counter sequence of 1 through 148 that corresponds to a given amount of data) during which transmit buffer module provides the data 204 to the MUX module 216 in preparation for burst transmission. Following the data 204, the counter postamble module 198 provides a counter sequence during which the postamble data 198 is provided to the MUX module 216.

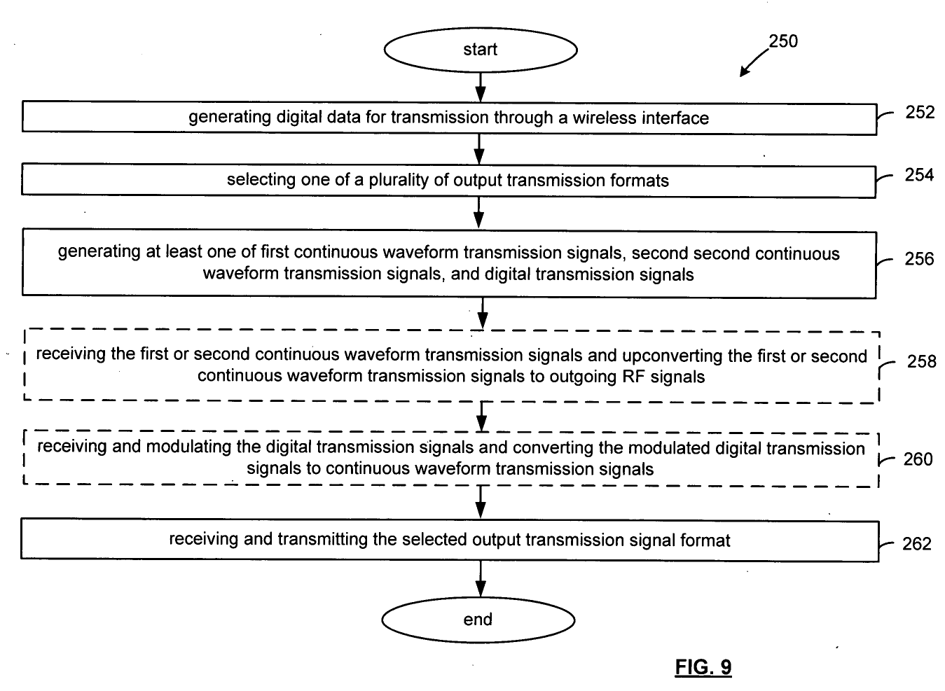

FIG. 9 is a flow chart illustrating a method for providing multiple signal formats wherein a selected one is output. The method 250 begins at step 252 by generating digital data for transmission through a wireless interface. At step 254, one of a plurality of output transmission formats is selected. At step 256, at least one of a first continuous waveform transmission signals, second continuous waveform transmission signals, and digital transmission signals is generated. The method then continues at step 262, where the selected output transmission signal format is received and transmitted, and then ends. Further optional steps are indicated by the dashed lines, particularly with respect to steps 258 and 260. At step 258, in which the method may continue from step 256, the first or second continuous waveform transmission signals are received and up-converted to outgoing RF signals. Then, at step 260, the digital transmission signals are received and modulated, which are then converted to continuous waveform transmission signals. Following the optional steps 258 and 260, the method then continues to step 262 where the selected output transmission signal format is received and transmitted. Afterwards, the process ends.

While the invention is susceptible to various modifications and alternative forms, specific embodiments thereof have been shown by way of example in the drawings and detailed description. It should be understood, however, that the drawings and detailed description thereto are not intended to limit the invention to the particular form disclosed, but, on the contrary, the invention is to cover all modifications, equivalents and alternatives falling within the spirit and scope of the present invention as defined by the claims. As may be seen, the described embodiments may be modified in many different ways without departing from the scope or teachings of the invention.

What is claimed is:

1. An integrated circuit radio transmitter, comprising:
a baseband processing module operable to generate digital data for transmission through a wireless interface;
first transmission logic for generating first continuous waveform transmission signals;
second transmission logic for generating second continuous waveform transmission signals;
third transmission logic for generating digital transmission signals;
logic for selecting an output transmission signal format including at least one of the first continuous waveform transmission signals, the second continuous waveform transmission signals, and the digital transmission signals; and
radio frequency (“RF”) transmission circuitry for receiving and transmitting the selected output transmission signal format.

2. The integrated circuit radio transmitter of claim 1 wherein the first continuous waveform transmission signals comprise baseband frequency waveform transmission signals.

3. The integrated circuit radio transmitter of claim 1 wherein the second continuous waveform transmission signals comprise very low intermediate frequency (“VLIF”) waveform transmission signals.

4. The integrated circuit radio transmitter of claim 1 wherein the second continuous waveform transmission signals comprise intermediate (“IF”) waveform transmission signals.

5. The integrated circuit radio transmitter of claim 1 wherein the RF transmission circuitry is operable to receive the first or second continuous waveform transmission signals and to upconvert the first or second continuous waveform transmission signals to outgoing RF signals.

6. The integrated circuit radio transmitter of claim 1 wherein the RF transmission circuitry is operable to receive and modulate the digital transmission signals and to convert the modulated digital transmission signals to continuous waveform transmission signals.

7. The integrated circuit radio transmitter of claim 6 wherein the RF transmission circuitry is further operable to upconvert the continuous waveform transmission signals to outgoing RF signals.

8. The integrated circuit radio transmitter of claim 1 wherein the selection logic further includes logic for determining whether to transmit the digital transmission signals in at least one of a burst mode and a stream mode.

9. The integrated circuit radio transmitter of claim 1 wherein the selection logic further includes logic for determining whether to include preamble data and postamble data.

10. The integrated circuit radio transmitter of claim 8 wherein the selection logic further includes logic for determining to transmit the digital transmission signals in at least one of a GPRS protocol and an EDGE protocol.

11. An integrated circuit baseband processing module operable to generate digital data for transmission through a wireless interface, comprising:
first transmission logic for generating first continuous waveform transmission signals;
second transmission logic for generating second continuous waveform transmission signals;
third transmission logic for generating digital transmission signals; and
logic for selecting an output transmission signal format including at least one of the first continuous waveform transmission signals, the second continuous waveform transmission signals, and the digital transmission signals.

12. The integrated circuit baseband processing module of claim 11 wherein the first continuous waveform transmission signals comprise baseband frequency waveform transmission signals.

13. The integrated circuit baseband processing module of claim 11 wherein the second continuous waveform transmission signals comprise very low intermediate frequency (“VLIF”) waveform transmission signals.

14. The integrated circuit baseband processing module of claim 11 wherein the second continuous waveform transmission signals comprise intermediate (“IF”) waveform transmission signals.

15. The integrated circuit baseband processing module of claim 11 further comprises:
radio frequency (“RF”) transmission circuitry operable to receive the first or second continuous waveform transmission signals and to upconvert the first or second continuous waveform transmission signals to outgoing RF signals.

16. The integrated circuit baseband processing module of claim 11 further comprises:
radio frequency (“RF”) transmission circuitry operable to receive and modulate the digital transmission signals and to convert the modulated digital transmission signals to continuous waveform transmission signals.

17. The integrated circuit baseband processing module of claim 16 wherein the RF transmission circuitry is further operable to upconvert the continuous waveform transmission signals to outgoing RF signals.

18. The integrated circuit baseband processing module of claim 11 wherein the selection logic further includes logic for determining whether to transmit the digital transmission signals in at least one of a burst mode and a stream mode.

19. The integrated circuit baseband processing module of claim 11 wherein the selection logic further includes logic for determining whether to include preamble data and postamble data.

20. The integrated circuit baseband processing module of claim 18 wherein the selection logic further includes logic for determining to transmit the digital transmission signals in at least one of a GPRS protocol and an EDGE protocol.

21. A method in a baseband processing module comprises:
generating digital data for transmission through a wireless interface;
selecting one of a plurality of output transmission formats;
generating at least one of first continuous waveform transmission signals, second continuous waveform transmission signals, and digital transmission signals; and
receiving and transmitting the selected output transmission signal format.

22. The method of claim 21 wherein the first continuous waveform transmission signals comprise baseband frequency waveform transmission signals.

23. The method of claim 21 wherein the second continuous waveform transmission signals comprise very low intermediate frequency (“VLIF”) waveform transmission signals.

24. The method of claim 21 wherein the second continuous waveform transmission signals comprise intermediate (“IF”) waveform transmission signals.

25. The method of claim 21 further comprises receiving the first or second continuous waveform transmission signals and upconverting the first or second continuous waveform transmission signals to outgoing RF signals.

26. The method of claim 21 further comprises receiving and modulating the digital transmission signals and converting the modulated digital transmission signals to continuous waveform transmission signals.

27. The method of claim 26 further including upconverting the continuous waveform transmission signals to outgoing RF signals.

28. The method of claim 21 further including determining whether to transmit the digital transmission signals in at least one of a burst mode and a stream mode.

29. The method of claim 21 further including determining whether to include preamble data and postamble data.

30. The method of claim 28 further including determining to transmit the digital transmission signals in at least one of a GMSK protocol and an EDGE protocol.
